(19) United States
(12) Patent Application Publication
(10) Pub. No.: US 2010/0166944 A1
(43) Pub. Date: Jul. 1, 2010

(54) METHOD FOR DETERMINING THE POLYESTER FRACTION OF A MULTI-COMPONENT POWDER DURING A THERMAL SPRAYING PROCESS, METHOD FOR COATING OR TOUCHING UP AN OBJECT BY MEANS OF A THERMAL SPRAYING PROCESS AND THERMAL SPRAYING DEVICE

(75) Inventors: Andreas Jakimov, Muenchen (DE); Manuel Hertter, Muenchen (DE); Andreas Kaehny, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/514,989

(22) PCT Filed: Nov. 2, 2007
(86) PCT No.: PCT/DE07/01971

§ 371 Date: Dec. 22, 2009

(30) Foreign Application Priority Data
Nov. 15, 2006 (DE) 10 2006 053 793.9

(51) Int. Cl. B05D 1/02; C23C 4/00; B05C 11/00

(52) U.S. Cl. 427/8; 118/612; 118/712

(57) ABSTRACT

A method for determining the polyester fraction in a multi-component powder during a thermal spraying process is disclosed. The multi-component powder is heated and fed to an object with the aid of a carrier, forming a coating on the object. At least one measured value for the intensity of the light emitted by the combination of the carrier and multi-component powder material on the way to the object is detected at least in the range of a characteristic wavelength of polyester. A characteristic value is derived from the combination of the measured values, and the fraction of the polyester to be determined is calculated on the basis of a previously determined relationship between the characteristic value and the polyester fraction.

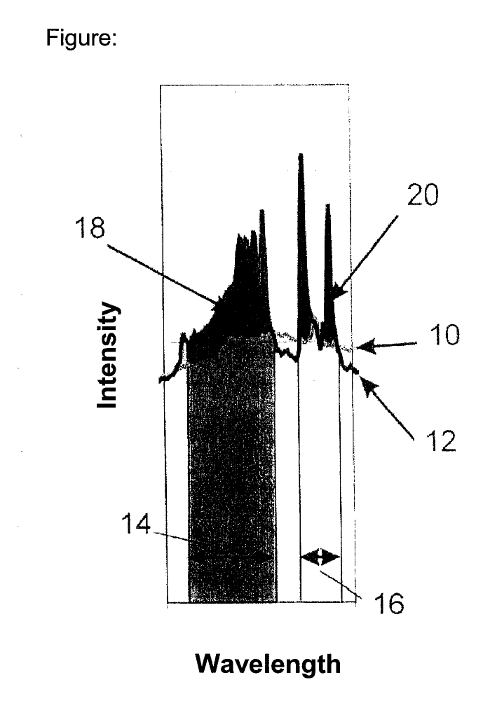

This application claims the priority of International Application No. PCT/DE2007/001971, filed Nov. 2, 2007, and German Patent Document No. 10 2006 053 793.9, filed Nov. 15, 2006, the disclosures of which are expressly incorporated by reference herein.

### BACKGROUND AND SUMMARY OF THE INVENTION

Method for determining the polyester fraction in a multi-component powder during a thermal spraying process, method for coating or touching up an object by means of a thermal spraying process and a thermal spraying device.

The invention relates to a method for determining the fraction of polyester in a multi-component powder during a thermal spraying process, in which the multi-component powder is used as the starting material, which represents the material for the to-be-applied layer during the coating of an object. The invention also relates to a method for coating or touching up an object by means of a thermal spraying process as well as a thermal spraying device.

Summarized under the concept of thermal spraying are completely different spraying methods, such as, for example, plasma spraying, electric arc spraying, laser spraying and flame spraying. Details about the different spraying methods may be found in the DIN 32530 as well as on the homepage of the Gemeinschaft Thermisches Spritzen (GTS), i.e., the Thermal Spraying Association, which on Oct. 25, 2006 could be accessed at www.gts-ev.de.

Common to the various spraying methods that fall under the term thermal spraying is that a material to be applied to an object is fed to a device for the thermal spraying process, and that thermal and kinetic energy is supplied to it there. A carrier is used to convey it to the location where it is supposed to be deposited as a coating. The carrier is normally a gas, which may also be ionized, namely in the case of plasma spraying.

Thermal spraying may be used in the case of a multitude of materials to be applied as a coating. In the case of coating or even touching up turbine parts and engine parts, which are used in an aircraft engine, using a multi-component powder that is comprised of the actual coating powder and a binding agent to which polyester is added has been proven. After burning out, the polyester provides for a desired porosity of the applied coating. It may also desirably influence the abrasive properties of the coating—when one is dealing with an intake coating in particular.

As a result, the polyester becomes an essential component of the multi-component powder. Unfortunately, it has not been possible until now to determine, during the thermal spraying process, the polyester fraction in the applied material, which is initially made available as a multi-component powder. Determining the fraction of polyester in a multi-component powder is particularly desirable therefore in order to facilitate control or regulation.

Therefore, it is the objective of the invention to make available for the first time a method for determining the fraction of polyester in a multi-component powder during a thermal spraying process and thus to indicate a way in which regulation or control is rendered possible.

In this case, the multi-component powder is also comprised of the coating material along with the polyester. The multi-component powder is comprised preferably also of a binder and possibly other additives.

According to the invention, in the case of the method for determining the polyester fraction in a multi-component powder during a thermal spraying process, at least one measured value for the intensity of the light emitted by the combination of the carrier and multi-component powder material on the way to the object is detected at least in the range of a characteristic emission wavelength of polyester. As is generally known, a characteristic emission wavelength is a wavelength, in which energy is preferably emitted, and which is identifiable against the background in the emission spectrum by a clear increase in intensity. A characteristic value is now derived from the combination of the measured values. Based on the previously determined (for example empirically) relationship between the characteristic value and the polyester fraction, the polyester fraction can be determined as desired from the characteristic value.

The invention makes use of the fact that the emission spectrum in the range of a characteristic emission wavelength of polyester depends in a sensitive way on the polyester fraction in the starting material (i.e., the multi-component powder).

In order to increase this, the material other than the polyester can also be taken in consideration. Then, in addition to the already cited first predetermined wavelength range around a characteristic emission wavelength of polyester, measured values for intensity are also recorded in at least one additional predetermined wave range that does not overlap with this first wave range around a characteristic emission wavelength of a material of the multi-component powder other than polyester. On the basis of these measured values, the characteristic value can then be formed as a relative quantity. The relative quantity can be formed for example from a relative quantity between a first integral extending beyond the first wavelength range and a second integral extending beyond all other wavelength ranges.

It has been shown that a range between 370 nm and 392 nm is suitable as a first predetermined wavelength range. This is preferably further limited to the range from 376 nm to 390 nm.

Along with the polyester, the multi-component powder includes the actual coating material, i.e., the material or materials (individually or pre-alloyed) of which the coating is ultimately comprised. In addition, a binder or other materials may also be contained. In the case of a binding agent that is typically used, two projecting emission peaks in a range of 392 nm to 400 nm are shown, which can be defined as another predetermined wavelength range and is preferably limited to the interval of 393 nm to 398.5 nm. At the same time, two other predetermined wavelength ranges can be defined, each around one of the peaks, for example from 393.3 nm to 395.3 nm and from 396.1 nm to 398.5 nm.

The measured values for intensity of the measured values determined by the combination of the carrier and multi-component powder material suffice for a rough determination of a relative quantity. If one would like to refine the definition of the characteristic value, then only the fraction of the multi-component powder in the emission spectrum should be taken into account. In order to be able to do this, in the course of a preliminary measurement of all wavelengths, for which measured values are being recorded, which are supposed to be used for forming the characteristic value, measured values are recorded for the intensity of the light emitted by the carrier alone with the absence of multi-component powder material. Then the difference of the intensities from the two measuring series (measured curves) is formed, i.e., with and without multi-component powder material, and this difference can be used to form the characteristic value. In the case of the above mentioned first and second wavelength ranges, the characteristic value can be determined via the difference curve as the relative quantity between two integrals.

In cases where the thermal spraying process is plasma spraying, a measured curve is recorded once when the plasma is being generated, but no multi-component powder is being fed to it, and a measured curve is again recorded during normal operation.

The fact that the invention is providing the opportunity for the first time to determine the polyester fraction in the multi-component powder material during the thermal spraying process, also renders an inventive method for coating or touching up an object by means of a thermal spraying process possible. A multi-component powder with polyester is used as the starting material. During the thermal spraying process, the polyester fraction of the multi-component powder material in the plasma beam and/or particle beam is determined multiple times or constantly, and this fraction is regulated to a predetermined value or at least regulated in such a way that it falls into a predetermined range of values.

The inventive method makes it possible to precisely specify especially those properties of the generated coating that are determined by the polyester, namely the porosity or the abrasive properties of the layer.

Control and regulation can be arranged in different ways in this case. The composition of the multi-component powder can be modified before it is fed to a device for the thermal spraying process. It is also possible to select a fixed powder composition and regulate the polyester fraction via the spray parameters, such as, for example, spray distance, gas flows, etc. In this case, the multi-component powder is produced in advance and merely the composition of the material that ends up on the to-be-coated object is still modified in the device for the thermal spraying process via these so-called indirect parameters.

In the first case, the multi-component powder is mixed separately from a device for the thermal spraying process in a mixing device prior to being fed to the device for the thermal spraying process from a minimum of the ingredients of polyester and coating material, possibly also binder or other additives. The generation of the multi-component powder is regulated in the mixing device in the process. This represents a simple solution in mechanical terms, because the device for the thermal spraying process does not have to be modified, the solution is involved, however, because the multi-component powder cannot be mixed in advance.

In the case of the second alternative, a device for the thermal spraying process is used, which is fed multi-component powder from a container previously filled with multi-component powder consisting of coating material, polyester and possibly binder and other additives. The ratio between polyester and the remaining ingredients of the multi-component powder is fixed in this case prior to spraying. Modifying the spray parameters regulates how much of the polyester impacts the surface being coated.

A typical object, which can be coated with the aid of the inventive method, is a turbine part or engine part, to which an intake coating in particular is being applied. As already mentioned, plasma spraying is especially suitable. For example, the emission of the plasma alone can be measured in advance especially well so that intensity values that are measured later can be related to the curve measured in advance.

The inventive device for thermal spraying renders the method according to the above-mentioned first alternative possible. It comprises a first feed device for a first ingredient of the multi-component powder and a second feed device for another ingredient of the multi-component powder. The material fed from the two feed devices is mixed at a location of the device, which is selected in such a way that the materials from the two feed devices mix when the device is in operation before they impact the object to be coated with the aid of a thermal spraying process. For example, the two feed devices are designed in such a way that the material is brought together in each case there where it is heated. Therefore, a nozzle is already used for the thermal spraying process so far, which guides the powder for example into a hot gas flow, where it melts, and a second nozzle can simply be provided as the second feed device, which can then direct powder, which comprises only one ingredient of the multi-component powder, in particular polyester powder, to the heated gas flow as well.

Regulation is accomplished as already mentioned. As a result, at least one of the feed devices (and namely preferably the second feed device of course) is controlled by a regulating device which analyzes signals of an optical spectrometer (which is directed at the light-emitting beam exiting from the device for the thermal spraying process).

### BRIEF DESCRIPTION OF THE DRAWING

A preferred embodiment of the invention will now be described in the following making reference to the drawing, which shows a section of two superimposed emission spectra, which were recorded and analyzed in the course of the inventive method.

### DETAILED DESCRIPTION OF THE DRAWING

In plasma spraying a multi-component powder is used as the starting material, which includes the actual coating powder, a binding agent and polyester powder as an additive. A stream of ionized gas (a plasma) is generated during plasma spraying, which serves as a carrier for a coating material, i.e., for the multi-component powder material in this case. The multi-component powder is injected into the flowing plasma, melts there, and the melted multi-component powder is carried to the to-be-coated object via the gas stream.

In addition to a conventional device for plasma spraying, an optical spectrometer is now provided, which is directed at the beam exiting from the device before it impacts the object. With the aid of the optical spectrometer, a first spectrum is recorded initially that emits from the plasma, if no multi-component powder is being supplied. This spectrum is designated by 10 in the FIGURE. Then the multi-component powder is fed and a second spectrum is recorded. This spectrum is designated by 12 in the FIGURE.

Now a first wavelength range 14 and a second wavelength range 16 can be defined, in which in each case the spectrum curve lies above the spectrum curve 10, i.e., wavelength ranges in which the emitted intensity with the multi-component powder is greater than without the multi-component powder. The first wavelength range 14 extends from 376.3 nm to 389.8 nm. Several peaks, which correspond to the characteristic emission wavelengths of polyester and binding agent, are visible in the curve 12 in the wavelength range 14. The increase in the curve 12 as compared with the curve 10 is therefore attributable to the polyester and the binding agent. The second wavelength range 16 extends from 393.3 nm to 398.5 nm. It can also be divided into two wavelength ranges of 393.3 nm to 395.3 nm, on the one hand, and from 396.1 nm to 398.5 nm, on the other hand, wherein what is said in the following about integrals over the second wavelength range 16 is supposed to apply then for the sum of integrals over the divided wavelength range. Two peaks can be seen in the curve 12 in the wavelength range 16, which are not present in curve 10. These two peaks can be attributed to the binding agent.

Now it is possible to determine the fraction of polyester in the multi-component powder from the area 18 between the curve 12 and the curve 10 in the wavelength range 14, on the one hand, and the area 20 between the curve 12 and the curve 10 in the wavelength range 16, on the other. The areas 18 and 20 can be computed as integrals of the difference of the intensity from the curve 12 from the intensity from the curve 10 over the wavelength range 14 or 16. The ratio from these integrals forms a characteristic value from which the polyester fraction in the multi-component powder can be determined. When plasma spraying is ongoing, the current polyester fraction in the multi-component powder can then be determined in the short term on the basis of the integral formation in the two spectra 10 and 12.

1-13. (canceled)

14. A method for determining a polyester fraction in a multi-component powder during a thermal spraying process, comprising the steps of heating and feeding the multi-component powder to an object with aid of a carrier, forming a coating on the object, and measuring a first value for an intensity of light emitted by the carrier and measuring a second value for an intensity of light emitted by a combination of the carrier and the multi-component powder, deriving a characteristic value from a comparison using the first and second measured values, and determining a fraction of polyester in the multi-component powder on a basis of a previously determined relationship between the characteristic value and the polyester fraction.

15. The method according to claim 14, wherein the first and second measured values are both recorded in a first predetermined wavelength range around a characteristic emission wavelength of polyester and in a second predetermined wavelength range that does not overlap with the first wavelength range around a characteristic emission wavelength of a material of the multi-component powder other than polyester, and, on a basis of the first and second measured values the characteristic value is formed as a relative quantity.

16. The method according to claim 15, wherein the first predetermined wavelength range extends from 370 nm to 392 nm.

17. The method according to claim 15, wherein the multi-component powder is comprised of polyester and a binding agent and wherein the second predetermined wavelength range extends from 392 nm to 400 nm.

18. The method according to claim 14, wherein the step of deriving a characteristic value from a comparison using the first and second measured values includes comparing a difference of the first and second measured values.

19. A method for coating or touching up an object by a thermal spraying process, wherein the process includes the method of claim 19 and further comprises, during the thermal spraying process, the fraction of polyester is determined multiple times or constantly, and regulated to a predetermined value or range of values.

20. The method according to claim 19, wherein, separate from a device for the thermal spraying process, the multi-component powder is mixed from at least polyester and coating material in a mixing device directly prior to being fed to the device for the thermal spraying process, and wherein a supply of polyester and/or coating material in the mixing device is regulated during generation of the multi-component powder.

21. The method according to claim 19, wherein a device for the thermal spraying process is used which is fed the multi-component powder from a container previously filled with the multi-component powder and wherein the fraction of polyester is regulated by spray parameters.

22. The method according to claim 19, wherein a turbine part or engine part is coated.

23. The method according to claim 19, wherein the thermal spraying process is plasma spraying.

24. A device for a thermal spraying process, comprising a first feed device for a first ingredient of a multi-component powder and a second feed device for a second ingredient of the multi-component powder, wherein the ingredients fed from the two feed devices are mixed at a location of the device such that the ingredients from the two feed devices mix when the device is in operation and before the multi-component powder impacts an object to be coated by a thermal spraying process.

25. The device according to claim 24, wherein the first and second ingredients are heated in the device.

26. The device according to claim 24, wherein at least one of the feed devices is controlled by a regulating device which analyzes signals of an optical spectrometer.
